(19) United States
(12) Patent Application Publication
(10) Pub. No.: US 2017/0261940 A1
(43) Pub. Date: Sep. 14, 2017

(54) SMART WATCH

(71) Applicant: Goertek Inc., Weifang City, ShanDong Province (CN)

(72) Inventor: Jingsong LIU, Weifang City (CN)

(73) Assignee: Goertek Inc., Weifang City, ShanDong Province (CN)

(21) Appl. No.: 15/035,623

(22) PCT Filed: Jan. 27, 2016
(86) PCT No.: PCT/CN2016/072355

§ 371 Date: May 10, 2016

(30) Foreign Application Priority Data
Oct. 27, 2015 (CN) 201520839338.6

(51) Int. Cl. G04G 9/00; G04G 21/08; G04B 19/04

(52) U.S. Cl. CPC G04G 9/00; G04B 19/04; G04G 21/08

(57) ABSTRACT

The present invention provides a smart watch, comprising a case and a bracelet. The smart watch further comprises: an electronic display, a pivot, hands and a rotatable pivot mounting member; the electronic display is provided with a through-hole at a specified location; the pivot is mounted inside the case and passes through the through-hole on the electronic display, a first end of the pivot that extends out from the back of the electronic display is connected to the pivot mounting member, the pivot is driven by the pivot mounting member to rotate about the axis when the pivot mounting member is rotating; a second end of the pivot that extends out from the front of the electronic display is equipped with the hands, the hands are driven by the pivot to rotate about the axis. Therefore, the smart watch comprises two output modes, electronic and mechanical, so it can greatly improve the richness of the output information without changing the size of the output interface of the smart watch, and thus complies with application requirements of smart watches.

### FIELD OF THE INVENTION

The present invention relates to the field of smart devices, and more particularly to a smart watch.

### BACKGROUND OF THE INVENTION

With the development of mobile technology, smart watch, as a hot spot in the intelligent terminal industry, is applied in an increasingly broad field. Due to the limitation of application scenario, the screen of the smart watch is generally smaller, resulting in restriction of the displayed output information. Since time information, as an indispensable display item of the smart watch, always occupies some space of the screen, little space is left on the screen for displaying other information. Therefore, the information output by the smart watch is not rich enough, which does not comply with the development trend of the application of smart watches.

### SUMMARY OF THE INVENTION

In view of the above problems, the present invention provides a smart watch to solve or at least partially solve the above problems.

According to one aspect of the present invention, a smart watch is provided, which comprises a case and a bracelet, and the smart watch further comprises: an electronic display, a pivot, hands and a rotatable pivot mounting member;

the electronic display is provided with a through-hole at a specified location;

the pivot is mounted inside the case and passes through the through-hole on the electronic display, a first end of the pivot that extends out from the back of the electronic display is connected to the pivot mounting member, the pivot is driven by the pivot mounting member to rotate about the axis when the pivot mounting member is rotating;

a second end of the pivot that extends out from the front of the electronic display is equipped with the hands, the hands are driven by the pivot to rotate about the axis.

Alternatively, the pivot mounting member is a gear set.

Alternatively, the through-hole is provided in the central portion of the electronic display.

Alternatively, the pivot is formed by embedding three co-axial hollow pivots in each other, the three co-axial hollow pivots include: a first pivot, a second pivot, and a third pivot;

the hands include an hour hand, a minute hand and a second hand;

the gear set includes a first gear, a second gear and a third gear; wherein each rotation of the first gear at a first predetermined angle drives the second gear to rotate 1/60 of the first predetermined angle, and each rotation of the second gear at the first predetermined angle drives the third gear to rotate 1/60 of the first predetermined angle;

A first end of the first pivot that extends out from the hack of the electronic display is connected to the first gear, a second end of the first pivot that extends out from the front of the electronic display is connected to the second hand; a first end of the second pivot that extends out from the hack of the electronic display is connected to the second gear, a second end of the second pivot that extends out from the front of the electronic display is connected to the minute hand; a first end of the third pivot that extends out from the back of the electronic display is connected to the third gear, a second end of the third pivot that extends out from the front of the electronic display is connected to the hour hand.

Alternatively, the smart watch further comprises: a motor that drives the gear set to rotate.

Alternatively, the smart watch further comprises: a mechanical energy storage structure that drives the gear set to rotate.

Alternatively, the smart watch further comprises: a touch screen having a predetermined transparency;

the touch screen is fixed over the front of the electronic display, such that the hands are located between the touch screen and the electronic display without contact with the touch screen and the electronic display.

Alternatively, the smart watch further comprises: a display driver circuit, a touch screen driver circuit and a micro control unit;

the electronic display is connected to the display driver circuit, the display driver circuit is connected to the micro control unit;

the touch screen is connected to the touch screen driver circuit, the touch screen driver circuit is connected to the micro control unit.

Alternatively, the electronic display is a liquid crystal display,

Alternatively, the case is configured to fix the positions of the electronic display and the touch screen.

According to the above contents, the smart watch provided by the present solution is provided with a mechanical transmission structure composed of a pivot mounting member, a pivot and hands. Both the mechanical transmission structure and the electronic display can be used for the display and output of the smart watch, thereby realizing the combination of electronic output and mechanical output in smart watches. Under this solution, since the smart watch can indicate the user time information by the mechanical transmission structure, other non-time information can be displayed on the electronic display based on actual demand, and it is unnecessary to leave some space on the electronic display for displaying time information as an indispensable display item. As can be seen, the cooperation of these two output modes can greatly improve the richness of the output information without changing the size of the output interface of the smart watch, and thus complies with application requirements of smart watches.

### BRIEF DESCRIPTION OF THE DRAWINGS

FIG. 1 shows a cross-sectional view of a smart watch according to one embodiment of the invention; and

FIG. 2 shows a front view of a smart watch according to one embodiment of the invention.

### DETAILED DESCRIPTION OF THE PREFERRED EMBODIMENTS

To make the object, technical solution and advantages of the present invention clearer, the embodiments of the present invention are described in further detail with reference to drawings.

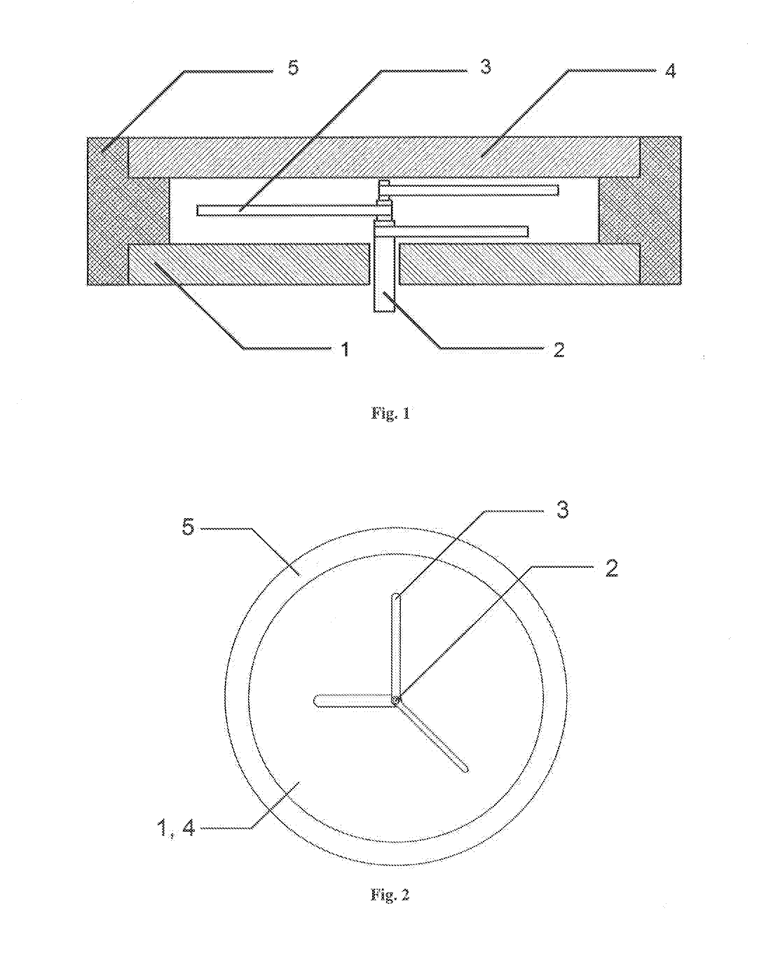

FIG. 1 shows a cross-sectional view of a smart watch according to one embodiment of the invention, the direction of the cross-section is vertical to the dial of the smart watch. As shown in FIG. 1, the smart watch comprises: an electronic display 1, a pivot 2, hands 3, a touch screen 4, a case 5 and a bracelet (not shown).

Case 5 is configured to fix the positions of electronic display 1 and touch screen 4. Electronic display 1 is provided with a through-hole at a specified location; pivot 2 is mounted inside case 5 and passes through the through-hole on electronic display 1. The smart watch further comprises a pivot mounting member. The first end of pivot 2 that extends out from the back of electronic display 1 is connected to the pivot mounting member, and pivot 2 is driven by the pivot mounting member to rotate about the axis when the pivot mounting member is rotating; the second end of pivot 2 that extends out from the front of electronic display 1 is equipped with hands 3, and hands 3 are driven by pivot 2 to rotate about the axis when pivot 2 is rotating, Touch screen 4 has a predetermined transparency and is fixed over the front of electronic display (e.g., a liquid crystal display (LCD)), such that hands 3 are located between touch screen 4 and electronic display 1 without contact with touch screen 4 and electronic display 1.

FIG. 2 shows a front view of a smart watch according to one embodiment of the invention. Under the perspective of FIG. 2, electronic display 1 and touch screen 4 overlap each other. Hands 3 include an hour hand, a minute hand and a second hand, A through-hole is provided at the center of electronic display 1. Pivot 2 is mounted inside case 5 and passes through the through-hole at the center of electronic display 1. It is merely a preferred embodiment of the invention to provide the through-hole at the center of electronic display 1 (i.e., dial). The through-hole may also be provided at other positions of the electronic display, In addition to the center, one or more auxiliary through-holes may be provided at the other positions aside from the center. For example, an auxiliary through-hole is provided in the area around the center, auxiliary hands are mounted on the auxiliary through-hole via an adaptive auxiliary pivot, the auxiliary pivot is connected to a rotatable auxiliary pivot mounting member, and the auxiliary pivot is driven by the auxiliary pivot mounting member to rotate about the axis when the auxiliary pivot mounting member is rotating.

Due to the small size of the dial, in one configuration, the auxiliary pivot and the auxiliary hands are smaller in size than the pivot and the hands; and the aperture of the auxiliary through-hole is smaller than the aperture of the through-hole.

This configuration can realize dual display (e.g., displaying dual time zones) or multifunction display (e.g., displaying pressure and direction while displaying time), to meet the needs in various functions and scenes.

More specifically, in the smart watch shown in FIGS. 1-2, the pivot mounting member is a gear set, the gear set comprising a first gear, a second gear and a third gear, wherein each rotation of the first gear at a first predetermined angle drives the second gear to rotate 1/60 of the first predetermined angle, and each rotation of the second gear at the first predetermined angle drives the third gear to rotate 1/60 of the first predetermined angle; pivot 2 is formed by embedding three co-axial hollow pivots in each other, the three co-axial hollow pivots are a first pivot, a second pivot, and a third pivot; hands 3 include an hour hand, a minute hand and a second hand. The first end of the first pivot that extends out from the back of electronic display 1 is connected to the first gear, the second end of the first pivot that extends out from the front of electronic display 1 is connected to the second hand; the first end of the second pivot that extends out from the back of electronic display 1 is connected to the second gear, the second end of the second pivot that extends out from the front of electronic display 1 is connected to the minute hand; the first end of the third pivot that extends out from the back of electronic display 1 is connected to the third gear, the second end of the third pivot that extends out from the front of electronic display 1 is connected to the hour hand.

In this embodiment, the rotation of the first gear synchronously drives the rotation of the first pivot around the axis, and the rotation of the first pivot synchronously drives the rotation of the second hand around the axis; the rotation of the second gear synchronously drives the rotation of the second pivot around the axis, and the rotation of the second pivot synchronously drives the rotation of the minute hand around the axis; the rotation of the third gear synchronously drives the rotation of the third pivot around the axis, and the rotation of the third pivot synchronously drives the rotation of the hour hand around the axis. Since each rotation of the first gear at a first predetermined angle drives the second gear to rotate 1/60 of the first predetermined angle, and each rotation of the second gear at the first predetermined angle drives the third gear to rotate 1/60 of the first predetermined angle, it can be seen that after each rotation of the second hand at the first predetermined angle, the minute hand rotates 1/60 of the first predetermined angle; and after each rotation of the minute hand at the first predetermined angle, the hour hand rotates 1/60 of the first predetermined angle, thereby realizing the timing rules of second hand, minute hand and hour hand.

For the smart watch provided by the present invention, the gear set may be driven by a motor to rotate, that is, the motor converts the input electrical energy into mechanical energy and transmits the mechanical energy to the gear set to drive the gear set to rotate. The gear set may also be driven by a mechanical energy storage structure, such as a tourbillon structure, to rotate, that is, the mechanical energy storage structure directly transmits the input mechanical energy to the gear set to drive the gear set to rotate.

Further, the smart watch provided by the present invention further comprises: a display driver circuit, a touch screen driver circuit and a micro control unit; wherein electronic display 1 is connected to the display driver circuit, and the display driver circuit is connected to the micro control unit; touch screen 4 is connected to the touch screen driver circuit, and the touch screen driver circuit is connected to the micro control unit; the micro control unit on the one hand controls the display and output of electronic display 1 via the display driver circuit according to default logic, and on the other hand receives the input signal of touch screen 4 via the touch screen driver circuit and responds to the input signal of touch screen 4 according to default logic, so as to realize the electronic output and input mechanisms of smart watches.

In one embodiment of the present invention, electronic display 1 of the smart watch provided by the present invention is a liquid crystal display (LCD).

In one embodiment of the present invention, the smart watch provided by the present invention further comprises a GPS module, a wireless communication module, etc, adapted to provide further functions such as positioning and communicating.

To sum up, the smart watch provided by the present solution is provided with a mechanical transmission structure composed of a pivot mounting member, a pivot and hands. Both the mechanical transmission structure and the electronic display can be used for the display and output of the smart watch, thereby realizing the combination of electronic output and mechanical output in smart watches. Under this solution, since the smart watch can indicate the user time information by the mechanical transmission structure, other non-time information can be displayed on the electronic display based on actual demand, and it is unnecessary to leave some space on the electronic display for displaying time information as an indispensable display item. As can be seen, the interoperation of these two output modes can greatly improve the richness of the output information without changing the size of the output interface of the smart watch, and thus complies with application requirements of smart watches.

The foregoing is only preferred embodiments of the present invention, and they are not used for limiting the protection scope of the present invention. Any modification, equivalent replacement and improvement within the spirit and principles of the present invention should be included in the protection scope of the present invention.

1. A smart watch, comprising a case and a bracelet, and further comprises: an electronic display, a pivot, hands and a rotatable pivot mounting member;
the electronic display is provided with a through-hole at a specified location;
the pivot is mounted inside the case and passes through the through-hole on the electronic display, a first end of the pivot that extends out from the back of the electronic display is connected to the pivot mounting member, the pivot is driven by the pivot mounting member to rotate about the axis when the pivot mounting member is rotating;
a second end of the pivot that extends out from the front of the electronic display is equipped with the hands, the hands are driven by the pivot to rotate about the axis.

2. The smart watch according to claim 1, wherein the pivot mounting member is a gear set.

3. The smart watch according to claim 1, wherein the through-hole is provided in the central portion of the electronic display.

4. The smart watch according to claim 2, wherein,
the pivot is formed by embedding three co-axial hollow pivots in each other, the three co-axial hollow pivots including: a first pivot, a second pivot, and a third pivot;
the hands include an hour hand, a minute hand and a second hand;
the gear set includes a first gear, a second gear and a third gear; wherein each rotation of the first gear at a first predetermined angle drives the second gear to rotate 1/60 of the first predetermined angle, and each rotation of the second gear at the first predetermined angle drives the third gear to rotate 1/60 of the first predetermined angle;
a first end of the first pivot that extends out from the back of the electronic display is connected to the first gear, a second end of the first pivot that extends out from the front of the electronic display is connected to the second hand; a first end of the second pivot that extends out from the back of the electronic display is connected to the second gear, a second end of the second pivot that extends out from the front of the electronic display is connected to the minute hand; a first end of the third pivot that extends out from the back of the electronic display is connected to the third gear, a second end of the third pivot that extends out from the front of the electronic display is connected to the hour hand.

5. The smart watch according to claim 2, wherein the smart watch further comprises: a motor that drives the gear set to rotate.

6. The smart watch according to claim 2, wherein the smart watch further comprises: a mechanical energy storage structure that drives the gear set to rotate.

7. The smart watch according to claim 1, wherein the smart watch further comprises: a touch screen having a predetermined transparency; and
the touch screen is fixed over the front of the electronic display, such that the hands are located between the touch screen and the electronic display without contact with the touch screen and the electronic display.

8. The smart watch according to claim 7, wherein the smart watch further comprises: a display driver circuit, a touch screen driver circuit and a micro control unit;
the electronic display is connected to the display driver circuit, the display driver circuit is connected to the micro control unit;
the touch screen is connected to the touch screen driver circuit, the touch screen driver circuit is connected to the micro control unit.

9. The smart watch according to claim 1, wherein the electronic display is a liquid crystal display.

10. The smart watch according to claims 1, wherein the case is configured to fix the positions of the electronic display and the touch screen.

11. The smart watch according to claims 1, wherein the electronic display is further provided with one or more auxiliary through-holes at positions different from the specified position; and the smart watch further comprises an auxiliary pivot, auxiliary hands and a rotatable auxiliary pivot mounting member that are adaptive to each of the auxiliary through-holes.

12. The smart watch according to claim 11, wherein the auxiliary pivot and the auxiliary hands are smaller in size than the pivot and the hands; and the aperture of the auxiliary through-hole is smaller than the aperture of the through-hole.
